(19) United States
(12) Patent Application Publication
(10) Pub. No.: US 2013/0003390 A1
(43) Pub. Date: Jan. 3, 2013

(54) Novel Waterproof Decorative Lamp

(76) Inventor: Xiao Xin WU, Guangdong (CN)

(21) Appl. No.: 13/532,793

(22) Filed: Jun. 26, 2012

(30) Foreign Application Priority Data
Jun. 28, 2011 (CN) 201120222001.2

(51) Int. Cl. F21V 3/00

(52) U.S. Cl. 362/311.02

(57) ABSTRACT

A novel beautiful waterproof decorative lamp comprising an LED lamp bead and two conductors integrally connected to the positive and negative feet of the LED lamp bead: wherein, a separation column is arranged between the positive and negative feet of the LED lamp bead to prevent short circuit between the two feet, the separation column is sheathed with a heat-shrinkable plastic sleeve and the LED lamp bead is covered with a diffuser On both sides of the separation column are grooves into which the conductors and the positive and negative feet of the LED lamp bead can be inserted, and the cross section of the separation column is I-shaped. The exterior of the plastic sleeve is covered with an injection molded piece which is used to increase the tension strength and service life of the conductor piece.

### BACKGROUND OF THE INVENTION

The present utility model relates to the field of outdoor decorative lighting technology, in particular, to a beautiful outdoor waterproof decorative lamp.

With the development of society, in addition to the known lighting function, lamps are used as a decoration means on many occasions. For example, on days of jubilation or festival, people often ornament the house with decorative lamps such as the decorative string lights. Varicolored decorative lights have a strong decorative effect on ambient environment.

It is because decorative lamps can beautify the environment and heighten the atmosphere that many decorative lamp manufacturers endeavor to introduce various decorative lamps with simple structure, low cost and good effect.

However, due to reasons of structure, many production processes of existing decorative lamps have to be completed manually. In the production of existing decorative string lights, usually it is required that first the positive and negative feet of the LED lamp bead penetrate a cylindrical insulation piece through two holes and then be welded to the conductor of the string lights, both steps requiring manual operation. Short circuit is apt to happen in the process of welding the positive and negative feet of the LED lamp bead to the conductor of the string lights due to the limitation of structure and production technology. Moreover, the through-holes in the insulation piece are so small for the positive and negative feet of the LED lamp bead to go through that the operation must be completed manually, resulting in low production efficiency and high labor costs.

### BRIEF SUMMARY OF THE INVENTION

The technical problem to be solved by the present utility model is to provide a novel decorative lamp which may realize automatic production in all processes, with high efficiency, strong water tightness and improved service life.

In order to solve the above-said technical problem, the technical solution of the present utility model is as follows:

A novel waterproof decorative lamp comprises an LED lamp bead and two conductors integrally connected to the positive and negative feet of the LED lamp bead; wherein, a separation column is arranged between the positive and negative feet of the LED lamp bead to prevent short circuit between the two feet, the separation column is sheathed with a heat-shrinkable plastic sleeve for tightly fixing the said separation column and the LED lamp bead is covered with a diffuser.

On both sides of the said separation column are grooves into which the conductors and the positive and negative feet of the LED lamp bead can be inserted. The separation column is a cylindrical body as a whole with a flange portion at the bottom, and the cross section of the upper part of the separation column is I-shaped. The said plastic sleeve is a heat-shrinkable plastic sleeve. The exterior of the plastic sleeve is covered with an injection molded piece which is used to increase the tension strength of the conductor.

Compared with the prior art, the present utility model has the following remarkable advantages:

Production of the novel decorative lamp according to the present utility model may realize automatic operation, high efficiency and low cost. The utility model improves the structure of the lamp body by changing the insulation piece which separates the positive and negative feet of the LED lamp bead into a separation column with an I-shaped cross section. After the positive and negative feet of the LED lamp bead are automatically welded to the conductors, the separation column of this shape may be arranged between them by an automatic procedure.

A heat-shrinkable plastic sleeve is arranged outside the separation column of the said novel waterproof decorative lamp to improve water tightness. In addition, an injection molded piece is also arranged outside the heat-shrinkable plastic sleeve, which not only further improves waterproof effect but also increases the tension strength and service life of the decorative string lights.

### BRIEF DESCRIPTION OF THE DRAWINGS

FIG. 1 is an appearance diagram of the waterproof decorative lamp according to the present utility model;

FIG. 2 is a structural diagram of the waterproof decorative lamp as described in FIG. 1 without the diffuser and the injection molded piece;

FIG. 3 is a structural diagram of the separation column arranged between the positive and negative feet of the LED lamp bead;

FIG. 4 is a breakdown diagram of FIG. 3.

### DETAILED DESCRIPTION OF THE INVENTION

For those skilled in the art to better understand the structural principle of the present utility model, a detailed description is given as follows by referring to the attached drawings.

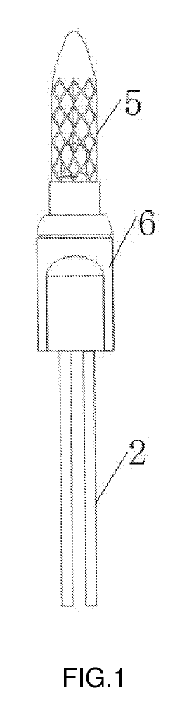

Refer to FIGS. 1˜4. A novel waterproof decorative lamp consists of an LED lamp bead 1, two conductors 2 integrally connected to the positive and negative feet of the LED lamp bead, a separation column 3, a plastic sleeve 4, a diffuser 5 and an injection molded piece 6.

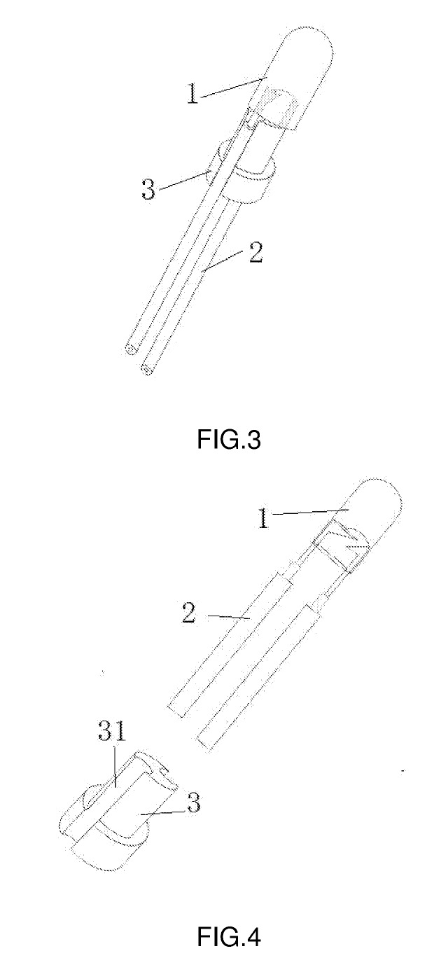

Grooves 31 are arranged on two sides of the separation column 3. The separation column is a cylindrical body as a whole with a flange portion at the bottom, and the cross section of the upper part of the separation column is I-shaped. After the positive and negative feet of the LED lamp bead are welded to the conductor 2, the positive and negative feet of the LED lamp bead and the conductor 2 will be wedged into the grooves 31 on both sides of the separation column. The isolating portion in the middle of the separation column will isolate the positive electrode from the negative electrode of the conductors to prevent short circuit. The grooves on both sides of the separation column have a function of fastening the conductor. Refer to FIG. 3 for the details of the separation column.

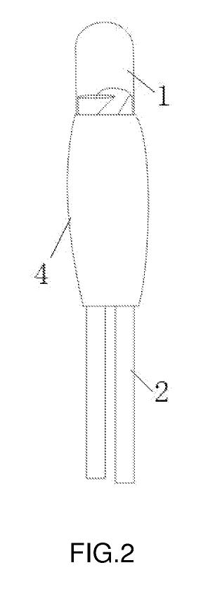

After the separation column is put in place, sheathe it with the cylindrical heat-shrinkable plastic sleeve and cover the weld between the positive and negative feet of the LED lamp bead and the conductor 2, and then fix it in a hot-shrinkable manner. Due to the flange portion at the lower part of the separation column, the bonding force between the separation column 3 and the heat-shrinkable plastic sleeve can be strengthened. In this way, the heat-shrinkable plastic sleeve not only fastens the separation column 3, but also ensures water tightness of the product. Refer to FIG. 2 for details.

Subsequently, enclose the product that has undergone thermal shrinking treatment in diffuser 5 which may be made of transparent glass or PS plastics. The diffuser 5 is used not only to protect the LED lamp bead but also to let light rays pass through it.

In order to further improve water tightness, an injection molded piece 6 is arranged outside the heat-shrinkable plastic sleeve of the product, which not only produces an additional waterproof effect but also increases the tension strength of the decorative string lights and improves service life.

In the waterproof decorative lamp disclosed by the present utility model, after the positive and negative feet of the LED lamp bead and the conductor are welded together automatically, the innovatively designed separation column can be arranged between them through an automatic procedure. The production process of the utility model can realize efficient and cost-effective automatic operation.

The above embodiment is only one of the ways to realize the present utility model. There may be other similar embodiments without deviating from the basic principles and innovative concept of the present utility model and all such embodiments shall fall within protection scope of the present utility model.

What is claimed is:

1. A novel waterproof decorative lamp comprising an LED lamp bead (1) and two conductors (2) integrally connected to the positive and negative feet of the LED lamp bead; wherein, a separation column (3) is arranged between the positive and negative feet of the LED lamp bead to prevent short circuit between the two feet, the separation column is sheathed with a plastic sleeve (4) for tightly fixing the said separation column, and the LED lamp bead (1) is covered with a diffuser (5).

2. A novel waterproof decorative lamp according to claim 1, characterized in that, on both sides of the said separation column (3) are grooves (31) into which the conductors and the positive and negative feet of the LED lamp bead can be inserted. The separation column is a cylindrical body as a whole with a flange portion at the bottom, and the cross section of the upper part of the separation column is I-shaped.

3. A novel waterproof decorative lamp according to claim 2, characterized in that, the said plastic sleeve (4) is a heat-shrinkable plastic sleeve.

4. A novel waterproof decorative lamp according to any one of claims 1˜3, characterized in that, the exterior of the plastic sleeve (4) is covered with an injection molded piece (6) which is used to increase the tension strength of the conductor.
